(19) United States
(12) Patent Application Publication
(10) Pub. No.: US 2004/0197924 A1
(43) Pub. Date: Oct. 7, 2004

(54) Liquid absorptometry method of providing product consistency

(76) Inventors: Lawrence J. Murphy, Bedford, MA (US); Steven R. Reznek, Concord, MA (US); Ian D. Morrison, Acton, MA (US); Steven E. Brown, Tyngsboro, MA (US)

Correspondence Address: Martha Ann Finnegan, Esq., Cabot Corporation, 157 Concord Road, Billerica, MA, 01821-7001, US

(21) Appl. No.: 10/650,125

(22) Filed: Aug. 27, 2003

Related U.S. Application Data
(60) Provisional application No. 60/459,230, filed on Apr. 1, 2003.
(60) Provisional application No. 60/485,964, filed on Jul. 10, 2003.
(60) Provisional application No. 60/485,965, filed on Jul. 10, 2003.
(60) Provisional application No. 60/491,632, filed on Jul. 31, 2003.

(51) Int. Cl. G01N 35/08

(52) U.S. Cl. 436/55

(57) ABSTRACT

The present invention relates to a method of providing product consistency of a particulate material or the product containing the same, by maintaining at least one absorptometry value of the particulate material within a target range. The method may be used as a QA/QC method to insure product consistency.

This application claims the benefit under 35 U.S.C. §119(e) of prior U.S. Provisional Patent Application No. 60/459,230 filed Apr. 1, 2003, 60/485,964 filed Jul. 10, 2003, 60/485,965 filed Jul. 10, 2003, and 60/491,632 filed Jul. 31, 2003, which are all incorporated in its entirety by reference herein.

### BACKGROUND OF THE INVENTION

The present invention relates to methods for providing product consistency for particulate materials using liquid absorptometry.

In general, products of the chemical industry fall into one of two types—formulaic chemicals and performance chemicals. Formulaic chemicals are defined by their composition. If they are sold in different grades, the grades are distinguished by the concentration of impurities. Examples include ammonia, benzene, carbon tetrachloride, diethyl ether, and formaldehyde. Performance chemicals, which include polymers, dyes, pigments, and fragrances, are valued because of what they do, not what their composition is. Important types of performance chemicals include fine particle products such as carbon black, silica, titania, tantalum, calcium carbonate which are used in applications including reinforcement, rheology, color, and conductivity.

In order to insure consistency, specifications are set for fine particle products. Typically these specifications will include one or more measures of morphology and may further include one or more measures of chemical constituents. Common measures of morphology are particle size, surface area, structure, porosity, aggregate size, and aggregate shape. Common measures of chemistry include bulk and surface composition as well as analyses of extractable species. Measurements of variability of these properties can be made either during manufacturing to insure the process remains in control (often referred to as quality control, or QC) or on the product prior to shipment (often referred to as quality assurance, or QA).

For example, carbon black is typically sold with at least one morphological specification, which may be surface area, particle size, structure, and porosity. Performance tests, such as, for example, bound rubber or compound moisture absorption (CMA) tests may also be run, depending on the intended use for the carbon black.

Despite these quality control and quality assurance (QC/QA) efforts, it is not unusual for a customer to complain that a batch of product received did not perform as expected, despite being “within spec”. For example, variations in the rate of rubber cure, the appearance of white haze on molded rubber parts, low thixotropy in adhesives, and variations in plastic compounding times have all been traced back to lot-to-lot variations of carbon blacks even when each lot was within specification. This often results in the producer undertaking a thorough and costly study of the process and product and trying to make adjustments so that the product once again performs as expected.

Determining why a product did not perform as expected is inefficient and often both time consuming and expensive. It involves evaluation to assess why a problem has occurred rather than avoiding the problem in the first place. Many times, the producer will adjust manufacturing steps, not understanding the result but only in an attempt to change the product somehow to see a product difference. At times, this amounts to guess work.

Therefore, there is a need, especially in the particulate material industry, for methods in which product consistency can be routinely insured.

### SUMMARY OF THE INVENTION

The present invention relates to a method of providing product consistency comprising the steps of: a) obtaining a first absorptometry curve by combining a particulate material with a first liquid in an absorptometer; b) obtaining a second absorptometry curve by combining the particulate material with a second liquid in the absorptometer; c) extracting at least one value from the first absorptometry curve and at least one value from the second absorptometry curve; and d) maintaining the value from the first absorptometry curve within a first target range and maintaining the value from the second absorptometry curve within a second target range.

The present invention further relates to a method of providing product consistency comprising the steps of: a) obtaining an absorptometry curve by combining a particulate material with a liquid in an absorptometer; b) extracting at least two different values from the absorptometry curve; and c) maintaining the values within target ranges.

The present invention further relates to a method of providing product consistency comprising the steps of: a) obtaining an absorptometry curve by combining a particulate material with a liquid in an absorptometer; b) extracting at least one value from the absorptometry curve; and c) maintaining the value within a target range, wherein the liquid is not dibutyl phthalate or a hydrocarbon.

The present invention further relates to a method of providing product consistency comprising the steps of: a) obtaining an absorptometry curve by combining a particulate material with a liquid in an absorptometer; b) extracting at least one value from the absorptometry curve; and c) maintaining the value within a target range, wherein the value is not a characteristic volume.

The methods of the present invention, as herein described, can be used for quality control and/or quality assurance.

It is to be understood that both the foregoing general description and the following detailed description are exemplary and explanatory only and are intended to provide further explanation of the present invention, as claimed.

### BRIEF DESCRIPTION OF THE DRAWING

FIG. 1 shows a general single maximum absorptometry curve (torque versus volume) that can be obtained from the combination of a particulate material and a liquid in an absorptometer.

FIG. 2 show a multiple maxima general absorptometry curve (torque versus volume) that can be obtained from the combination of a particulate material and a liquid in an absorptometer.

FIG. 3 shows the maximum torque versus volume for the same grade of carbon black using various probe liquids.

### DETAILED DESCRIPTION OF THE INVENTION

The present invention relates to a method of providing product consistency. In more detail, the present invention relates to quality control and/or quality assurance systems and methods of maintaining quality control and/or quality assurance.

Particulate materials such as fillers and pigments are made within defined specifications but even doing so it has been found that the product at times would not perform consistently in the customer's application. Until now, the industry was not entirely clear why the product would not perform consistently even though it was within morphological specifications. Thus, until now, there was a major portion of quality control and quality assurance missing from the industry and/or the technology area. The present invention now makes it possible to maintain the same product within specifications, thereby providing to the customer a product that should perform consistently in their end product. Thus, the present invention not only affects the particulate material being made and has benefits to the particulate material being made, the present invention further has beneficial effects downstream such as permitting consistent end product performance wherein the particulate material is present in the end product. Thus, the present invention not only provides quality control and/or quality assurance for the particulate material but may also make it easier for a customer to obtain consistency in their product and any intermediate products containing the particulate material, such as polymer products, elastomeric products, inks, coatings, toners, and the like.

The method of the present invention involves the steps of maintaining at least one value obtained from an absorptometry curve of a particulate material within a target range. As used herein, “maintaining” can include measuring or analyzing for the value and determining whether that value falls within the desired target ranges. If it does, the value is said to be within specifications and is therefore maintained. If it does not, in order to keep the value maintained, some change is made in the process used to prepare the particulate material such that the value is brought back within range. In this way, the method of the present invention provides for product consistency by utilizing a system consisting of sampling, testing, comparison, selection, and optional process adjustment so that the product performs substantially the same.

Thus, the method of the present invention can be considered to be a quality assurance method and/or a quality control method. Quality assurance can include the steps of sampling a product periodically, making one or more measurements on the product, comparing the results of these measurement(s) with expected or target value(s), and then releasing the product based on sufficient agreement with the expected or target value(s). Quality control can include the steps of sampling a product periodically, making one or more measurements on the product, comparing the results of these measurement(s) with expected or target value(s), transforming the measurement(s) by means of formula(e) or algorithm(s) to determine if any operation in a production process needs to be changed, changing the production process appropriately, and repeating these steps until the product meets expected value(s).

The step of maintaining the value extracted from an absorptometry curve of the present invention is preferably done routinely, that is, the step is performed as a regular part of the manufacturing process and is done prior to a customer receiving the product. Thus, the method of present invention is a quality control and/or a quality assurance method in that measurements are made periodically on the product and the results compared to target value ranges prior to a customer ever receiving the product.

In more detail, one or more embodiments of the present invention relate to testing of the particulate material in order to maintain a consistent product. Thus, one aspect of some embodiments of the present invention involves the routine testing of the particulate material being made or already produced in order to insure that the product is consistent with respect to at least one value extracted from an absorptometry curve. Preferably, the routine testing for the value promotes and provides a consistent performance of the particulate material in its use by a customer and its performance in the final product and any intermediate product. Routine testing can include testing for the absorptometry value of the particulate material at regular time intervals, such as every hour or portion thereof, multiple hours, every day, every week, and the like. The routine testing can, in combination or in the alternative, be with respect to every batch or partial batch made of the particulate material. The routine testing can, alternatively or in combination, include testing for the absorptometry value with respect to intervals of amounts of material produced. For instance, every 1,000 pounds of the particulate material produced will trigger the test for the absorptometry value. Needless to say, the amounts of material produced that would trigger the testing can be decided by the manufacturer or customer. Also, routine testing in the alternative or in combination can be done prior to shipping. As can be seen, from the above, routine testing generally involves testing for the absorptometry value before any problem is uncovered and is done for purposes of quality control and/or quality assurance. The testing for the absorptometry value to insure product performance and to insure a consistent product in the embodiments of the present invention, avoids or at least minimizes any testing triggered by a problem being uncovered, particularly by the customer. In addition, the present invention preferably provides a significant cost savings to the manufacturer and/or customer since by following a quality control and/or quality assurance system of the present invention, the amount of rejected batches of particulate material should be minimized, if not completely eliminated, due to such a quality control and/or quality assurance system. Thus, this is an additional benefit of the present invention.

As part of the present invention, in one or more embodiments of the present invention, the present invention relates to a quality control system which includes a test for determining at least one value extracted from an absorptometry curve for a particulate material. The tests are described below. The quality control system can also include a device or medium to record at least one absorptometry value for the particulate material. This recording can be done temporarily or permanently (e.g., in writing, electronically, and the like), such as on paper or with a computer program, such as Excel or any other types of software for recording data. Optionally, this data can then be compared from test to test to determine consistency. The present invention further relates to a method for quality control which includes analyzing at least one value extracted from an absorptometry curve of a particulate filler on a routine basis to insure quality control. Furthermore, the present invention relates to a method for quality assurance which includes analyzing at least one value extracted from an absorptometry curve of a particulate material on a routine basis to insure quality assurance. The methods for quality assurance and/or quality control can further include analyzing at least one morphological value and/or at least one chemical value on a routine or non-routine basis to insure quality control and/or quality assurance.

Particulate materials are used in a variety of compounded systems, including, for example, dispersions in elastomers, polymers, solvents, resins, or mixtures thereof. Important aspects of performance include reinforcement, rheology control, formation of percolating networks, degree of dispersion, color, and conductivity.

The method of the present invention provides product consistency by maintaining at least one absorptometry value for a particulate material. Any particulate material may be used. The particulate material may be in any form such as a powder, a pellet, or a fluffy material. Examples of particulate materials include, but are not limited to, fillers, extenders, carbonaceous materials, carbon black, inorganic salts, silica (such as fumed silica, precipitated silica, or colloidal silica), silica aerogels, fumed oxides, silicates, silica sols including Stöber sols, metal oxides, hydrous metal oxides, iron oxides, aluminum oxides, boehmite, aluminum silicates, clays, kaolin, halloysite, montmorillonite, attapulgite, zeolites, ceramics (such as a metal carbide, a metal nitride, or a metal boride), calcium carbonate, chalk, barium sulfate, diatomaceous earth, asbestine, pigments (such as phthaolocyanines, Prussina blue, chromium oxide, and chrome green), zinc sulfide, zinc oxide, titania, antimony oxide, lead zinc, metals (such as tantalum, niobium, iron, aluminum, or silicon), and any of the above with surface treatments such as hydrophobic silicas, surface-modified carbon blacks, polymer treated powders, and laked pigments. Combinations or mixtures of these particulate materials may also be used. Examples of carbonaceous materials include, but are not limited to, carbon black, graphite, vitreous carbon, activated carbon, carbon fibers, nanotubes, graphite, and the like. Other examples include aggregates containing a carbon phase and a silicon-containing species phase or an aggregate containing a carbon phase with a metal-containing species phase. Also, coated particulate materials, such as silica-coated carbon black are other examples of particulate material. Furthermore, the carbonaceous material or other particulate material can be modified in any way such as having attached organic groups, polymer groups, and the like. Examples may include those described in U.S. Pat. Nos. 5,747,562, 5,830,930, 5,877,238, 5,904,762, 5,916,934, 5,919,841, 5,948,835, 6,008,272, 6,017,980, 6,028,137, 6,057,387, 6,197,274, 6,211,279, 6,323,273, 6,364,944, 6,448,309, all of which are incorporated in there entirety by reference herein.

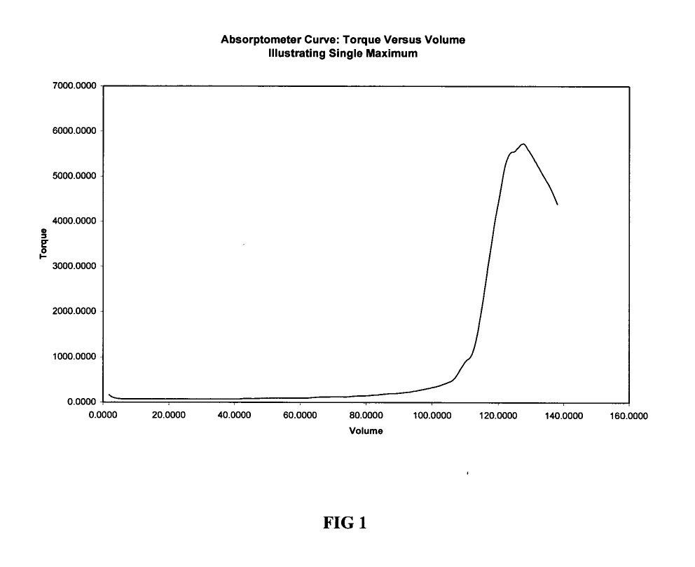

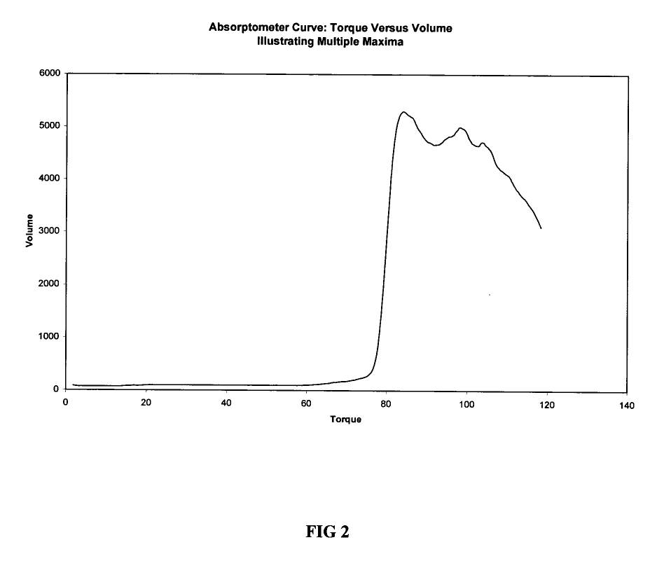

The method of the present invention comprises the step of obtaining an absorptometry curve for a particulate material using an absorptometer. An absorptometry curve is a graph of torque versus titration time obtained from an absorptometer. The titration time may be converted to the volume of liquid titrated or volume of liquid titrated per mass of powder. The latter is preferred. Examples of general absorptometry curves are shown in FIGS. 1 and 2.

Any absorptometer known in the art may be used. For example, the absorptometery may be an instrument having a mixing chamber into which a known mass of particulate material is added, a means of stirring the particulate material in the chamber at a controlled rate, a load cell or torque-measuring device on the drive to the stirrer, a means of adding a liquid to the mass of particulate material as it is stirred, and a means of recording the load, or torque, or viscosity during the addition of the liquid. Experimental conditions under which the absorptometer is run can be varied. Examples include the rate of liquid addition (such as the volume flow) and whether the rate is uniform, steady, or variable; the rotation rates of the stirrer, and whether the rate is uniform, steady, or variable; the temperature; the mass of particulate material used; the preparation of particulate material (for example as-received, crushed, dried, etc.); the surface finish of the bowl and/or stirrer; the volume and shape of the bowl; and the stirrer design (such as counter rotating, co-rotating, multiple blades or shafts, etc.). Also, the data collection and storage may be mechanical or electronic and may be periodic e.g. the torque at regular times such as once a second, or the torque at regular volumes such as after every ml added, or the torque at a specified time such as after 15 minutes, or at a specified volumes such as at 100 ml added, or the torque at a characteristic point on the absorption curve such as the maximum, or the volume at a characteristic point such as the volume at maximum torque. Other experimental variations will be known to one skilled in the art.

Absorptometry is used as a common type of QA/QC test for the structure of particulate materials such as carbon black. A liquid is added slowly to a mass of material as it is being stirred. As the ratio of the volume of liquid to the mass of particulate material increases, the torque required to mix changes. Typically, the ratio of the volume of liquid added to the mass of material at the maximum torque is reported as a QA/QC test for structure. Another QA/QC test is to report the same ratio at a predetermined fraction of the maximum torque. A preferred liquid is dibutyl phthalate (DBP), and the reported value is often referred to as the DBP number. Paraffin oil has also been used.

However, the flow of a particulate material wetted by a liquid also depends the relative strengths of particle-particle interactions and particle-liquid interactions. When an absorptometer test is repeated with a second liquid on the same particulate material, the relation between torque and volume of liquid added changes. For example, maximum torque may be different for the same particulate material in different liquids, or, alternatively, the volume of liquid added to reach the maximum torque may be different.

Therefore, in one embodiment of the method of the present invention, at least two absorptometry curves are obtained. At least one of the absorptometry curves is obtained by combining a first liquid and the particulate material, and at least one other absorptometry curve is obtained by combining the particulate material and a second liquid. The value from the two (or more) liquids are then maintained in order to provide product consistency.

Any liquid may be used that is substantially chemically inactive with the particulate material. Preferable liquids are non-toxic, non-volatile, non-dissolving, with a low enough viscosity that the maximum torque of the absorptometer is not exceeded, and with a flash point amenable to QA/QC use. The liquid may also be a mixture of components.

For this embodiment, the first liquid and second liquid are not the same. It is preferred that the liquids differ in physical properties such as in polarity parameter, dielectric constant, solvent strength, acid/base character, hydrophilic nature, hydrophobic nature, hydrogen donor strength, hydrogen acceptor strength, electron donor strength, electron acceptor strength, pK, dipole moment, or polarizability. Useful characterization of liquids are found in elutriants for comatography, Hansen solubility parameters or other solvent scales, and Gutmann or Drago acid/base scales. Examples of liquids which differ in physical properties include dibutyl phthalate, paraffin oil, propylene carbonate, bromonaphthalene, mesitylene, trichlorobenzene, ethylene glycol, and water. Mixtures of these liquids may also be used.

At least one value is then extracted from the obtained absorptometry curves. Any useful value may be used, including any of the following:

a) the ordinate, usually torque, at a given abscissa, usually volume added, on the absorptometry curve, or vice versa. Examples include the volume added to reach a given torque; the volume added at the maximum torque or one of the torque maxima, the volume added at a given fraction of the maximum torque or one of the torque maxima, the maximum torque or value of one of the torque maxima, or the torque at a given volume added, or a comparison of the values of two or more local maxima if more than one is recorded;

b) characteristics of the absorptometry curve, such as the slope at a given point (such as the maximum positive slope), the area under the curve between given volumes, the shape of the curve as the maximum torque is approached, the shape of the curve on the descending slope after the maximum, or the volume at which the torque is a given fraction above the minimum torque on the ascending curve; or

c) the fit of the curve to a given equation, or a fit of part of the curve to a given equation, or the width at half maximum, or the mean, mode, median, or any cumulant.

Other values that can be extracted include any of those described above either before or after the data has been smoothed. In addition, any of those values described above after the curve has been normalized, for example, by mass, by addition rate, or by some characteristic particulate property such as specific surface area, or by some physical property of the liquid such as viscosity, can also be used.

Any of the extracted values can also be used in combination. For example, two or more different values from the same absorptometry curve can be associated into an ordered sequence, e.g. the volume at maximum torque with the maximum torque. Also, two or more values from separate absorptometry curves can be associated into an ordered sequence, e.g. the maximum torque measured in two different liquids. Further, one value can be calculated from two or more values, e.g. the product of the maximum torque and the volume at the maximum torque from one absorptometry curve, or the ratio of the maximum torque measured in two different liquids. In addition, more than one value can be calculated from the values obtained, e.g. dividing all of the torque values on one absorptometry curve by the torque values on another absorptometry curve at the same volume added. Other combinations will be known to one skilled in the art.

In another embodiment, the method of the present invention comprises obtaining an absorptometry curve by combining a particulate material and at least one liquid and extracting from the curve at least two different values. The two (or more) values obtained in this way are then maintained in order to provide product consistency.

For this embodiment, the liquid can be any of those described above. In addition, the extracted values can be any of those described above. Since at least two values are extracted from the absorptometry curve, these values can also be used alone or in any combination, as described in more detail above.

In another embodiment of the present invention, the method of providing product consistency comprises the step maintaining at least one value extracted from an absorptometry curve obtained by combining a particulate material with at least one liquid. For this embodiment, the liquid is not dibutyl phthalate or a hydrocarbon, which is defined as a compound or mixture of compounds composed exclusively of carbon and hydrogen. Examples of hydrocarbons include paraffin oil, mineral oil, or alkanes such as hexadecane.

As stated above, absorptometry is used as a common type of QA/QC test for the structure of particulate materials such as carbon black. Dibutyl phthalate (DBP) or paraffin oil is typically used. Other liquids have not been used for providing product consistency since the flow of a dispersion of particulate material (or the packing of material in the liquid) is different for different liquids. In particular, DBP and paraffin oil have been used since these typically produce a maximum packing of the particular material, which provides useful information for morphology. Other liquids do not produce the same effect and are therefore less useful for morphological control. However, these additional liquids, as discussed above, do provide useful information since the relation between torque and volume of liquid added changes. For example, maximum torque may be different for the same particulate material in different liquids, or, alternatively, the volume of liquid added to reach the maximum torque may be different.

Therefore, for this embodiment of the present invention, any value may be extracted from the absoptometry curve, obtained by combining a liquid other than DBP or paraffin oil and a particulate material. This value is then maintained in order to provide product consistency. The liquids can be any of those described above, excluding DBP and paraffin oil, and the extracted values can also be any of those described above.

In another embodiment, the method of the present invention provides product consistency that comprises obtaining an absorptometry curve by combining a particulate material and at least one liquid and extracting at least one value from the curve which is not the characteristic volume. As stated above, as commonly used in the absorptometry QA/QC test for the morphology of particulate materials such as carbon black, the ratio of the volume of liquid added to the mass of material where the torque is a maximum, or a fraction of the maximum, is reported as a QA/QC test for structure. This is referred to as the characteristic volume. Other values are not extracted since they do not provide as much useful information concerning morphology.

Therefore, for this embodiment, any value other than the characteristic volume may be extracted from the absoptometry curve, obtained by combining a liquid and a particulate material. This value is then maintained in order to provide product consistency. The liquids can be any of those described above, and the extracted values can also be any of those described above, excluding the characteristic volume. Also, the extracted values can be used either alone or in combination, as is described in more detail above.

The method of the present invention may further comprise the step of maintaining at least one chemical value of the particulate material. The chemistry of a particulate material involves the material's overall (or bulk) composition, surface composition, and/or extractable materials. The types, quantities, and arrangement of chemical moieties at the surface is called the surface chemistry. For example, the surface of carbon black may include carbon-oxygen surface groups, carbon-hydrogen surface groups, and/or other substituted carbon groups.

The chemical value of the particulate material can be determined using any technique known in the art. For example, the amounts of chemical moieties can be measured by desorption (for example, desorption of oxygen groups on carbon black), neutralization of surface groups by acids and bases, potentiometric, thermometric, and radiometric titrations, direct analysis by specific chemical reactions, polarography, infrared spectroscopy (IR), electron spin resonance (ESR), and X-ray photoelectron spectroscopy (XPS). The surface chemistry may be altered by chemical reactions or by removing extractable materials.

Examples of chemical values include, but are not limited to, pH and functional group levels. It has been found that, in general, measurements of chemical components, along with measurements of morphology, are not able to efficiently achieve the desired level of product consistency. Particulate surfaces can contain a large number of different types of chemical species, and therefore far too many species would have to be identified and their relative positions on the surface determined in order to obtain effective quality control and assurance. Furthermore, while methods exist for qualitative and quantitative analysis, surface positioning is currently beyond the state of the art.

The method of the present invention may further comprise the step of maintaining at least one morphological value within a morphological target range. The morphological values of the particulate materials can be determined using any method known in the art, such as colloidal techniques, including liquid or vapor adsorption, microscopy, or combinations of thereof. Typical liquid or vapor probes for adsorption include nitrogen, iodine, cetyltrimethyl ammonium bromide (CTAB), dibutyl phthalate (DBP), or paraffin oil. Examples of useful microscopy techniques include, but are not limited to, transmission electron microscopy (TEM), X-ray diffraction, dark field microscopy, oxidation studies, diffracted beam electron microscopy, phase contrast transmission electron microscopy imaging, high resolution scanning electron microscopy (SEM), scanning tunneling electron microscopy (STEM), scanning tunneling microscopy (STM), scanning force microscopy (SFM), and atomic force microscopy (AFM) imaging. Examples of colloidal techniques include, but are not limited to, masstone (blackness or color), tinting strength (ASTM D 3265), and the adsorption of nitrogen gas data (ASTM D 3037), cetyltrimethyl ammonium bromide (ASTM D 3765), or iodine (ASTM D 1510). The surface areas derived from each of the above mentioned methods can be affected in different ways by the amount and type of porosity, as well as the chemical nature of the surface of the particulate material. Porosity can be estimated from the apparent extra surface area detected in the adsorption of small probes, e.g., nitrogen, over large probes, e.g., CTAB. The aggregate size can be estimated by TEM, disc centrifuge photosedimentometry, sedimentation field flow fractionation, capillary hydrodynamic fractionation, dynamic light scattering, and differential mobility. Aggregate shape can be estimated by oil adsorption, particularly DBP, specific volume from density-pressure curves, and TEM.

Examples of morphological properties and tests used to measure them are shown in Table 1 below. These morphological values may be used alone or in combination with other morphological values.

TABLE 1

| Morphological Property | Testing Method |
|---|---|
| Particle size and | Transition electron microscopy (TEM) |
| distribution | Calculation from surface area |
| | Masstone |
| Surface area | Nitrogen adsorption (ASTM D 3037) |
| | Iodine adsorption (ASTM 1510) |
| | CTAB adsorption (ASTM D 3765) |
| | Carman surface area |
| Pore size and distribution | Difference between nitrogen and CTAB |
| | surface areas |
| Aggregate size and | TEM |
| distribution | Light scattering |
| | Disc centrifuge |
| Aggregate shape | TEM |
| | Oil absorption |
| | DBP absorptometry |
| | Specific volume from density-pressure curves |

The values described above, including any of the values extracted from an absorptometry curve, the morphological value, and the chemical value, are all maintained within defined target ranges. The ranges will depend on the particular property being measured. Preferably, the ranges are based on a defined specification. For example, the target range for the value extracted from an absorptometry curve may be a range that is within about 50% (above or below) of the target value. Tighter specification ranges may also be used, such as within about 25%, within about 10%, within about 8%, within about 5%, or within about 0.5% to about 3% of the target value. The target range may also be a specified value that the specific value must either not exceed (a value that is less than the target) or must not be below, depending on the specific value and test. The target value can be determined based on the desired customer performance.

As stated above, the method of the present invention provides product consistency by maintaining at least one absorptometry value within a target range. In one embodiment, the step of maintaining this value comprises determining, measuring, or analyzing for at least one absorptometry value of the particulate material and adjusting at least one process variable of the process for producing the particulate material. The adjustment is made so that the absorptometry value is maintained within the corresponding target range. Preferably, the adjustment is made during the process for producing the particulate material. Thus, product is prepared, the properties are measured, the results are compared to the target values, and the process is accordingly adjusted, if necessary, so as to produce material having the desired absorptometry value. This is preferably done prior to the product being shipped to a customer.

A variety of different process variables can be adjusted in order to maintain the absorptometry value. The variable will depend on the type of particulate material. For examples, adjustable process variable for a particulate material comprising carbonaceous material and, in particular, carbon black include, but are not limited to combustion stoichiometry, reactor quench length, feedstock composition, primary fuel type, level of downstream additive (including oxidants and chemical reagents), and post treatment conditions. Examples of post treatments include those described in U.S. Pat. Nos. 5,554,739, 5,630,868, 5,672,198, 5,698,016, 5,707,432, 5,713,988, 5,803,959, 5,837,045, 5,851,280, 5,885,335, 5,895,552, 5,900,029, 5,922,118, 5,968,243, 6,042,643, and 6,494,946, each incorporated in their entirety by reference herein. If the particulate material comprises metal oxide, such as fumed silica, adjustable process variables would include combustion stoichiometry, amount of quench air, feedstock composition, primary fuel type, level of downstream additives, and post treatment conditions (including chemical modification).

The present invention will be further clarified by the following example which is intended to be only exemplary in nature.

### EXAMPLES

### Example 1

This example demonstrates the use of several liquids for obtaining absorptometry curves, from which two values—the maximum torque and the volume at maximum torque—are obtained for the same set of carbon blacks.

An absorptometer (available from C.W. Brabender Instruments, Inc., 50 E. Wesley St., South Hackensack, N.J. 07606) was used following the procedure described in ASTM test D-2414-01. Dibutyl phthalate (DBP) was added by means of a constant-rate buret to a sample of carbon black in the mixer chamber. A torque sensor detected the rise in viscosity from the free-flowing powder to the semi-plastic flow of the continuous mass. The absorptometer and buret were shut off when the torque passed through its characteristic maximum in such a fashion that there was assurance that the maximum torque had been reached. The volume of DBP per unit mass of carbon black was recorded as the DBP absorption number. CDBP values were obtained using a similar test in which the carbon black was pre-compressed before conducting the test. (ASTM D-3493)

This data is shown in Table 2, along with the iodine number and nitrogen, and STSA surface area values. These morphological values are reported as a percentage of the maximum values in the table. Note that, based on all of the values shown and, in particular, the values for the standard liquid DBP, these materials would be considered identical.

TABLE 2

| | % of max | % of max | | % of max | |
|---|---|---|---|---|---|
| | DBP number | CDBP | % of max | BET | % of max |
| | (cc/100 g) | (cc/100 g) | I₂No | surface area | STSA |
| Sample | @70% | @70% | (mg/g) | (m²/g) | (m²/g) |
| CB-A | 100 | 100 | 91.1 | 97.6 | 95.1 |
| CB-B | 99.2 | 96.4 | 95.6 | 95.1 | 92.7 |
| CB-C | 98.3 | 96.3 | 95.6 | 97.6 | 97.6 |
| CB-D | 99.2 | 94.0 | 97.8 | 100 | 100 |
| CB-E | 98.3 | 100 | 100 | 100 | 97.6 |

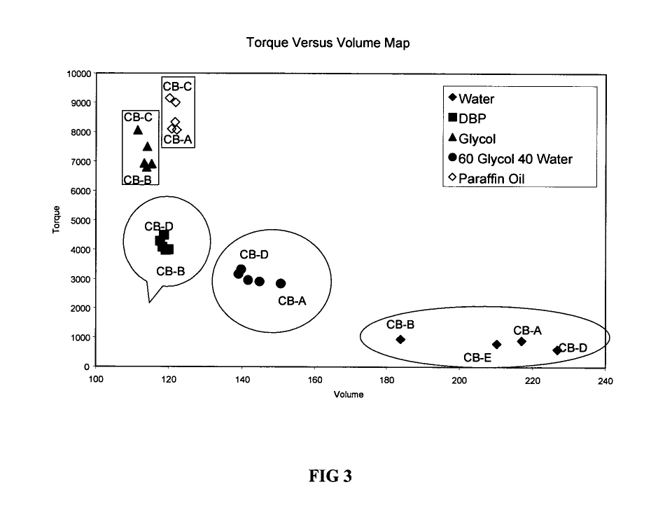

A similar absorptometry procedure was followed, using paraffin oil, ethylene glycol, water, and a 60/40 mixture of ethylene glycol and water. Results are show in FIG. 3. As can be seen, the values for the measured parameters in ethylene glycol are different for each sample. The same is true for the paraffin oil. Significant separations between the morphologically identical samples of carbon black are found when a 60/40 ethylene glycol/water (60 parts ethylene glycol by volume and 40 parts water by volume) or just pure water is used. In addition, the ordering of the samples (the carbon black samples that represent the high and low values are shown in FIG. 3) changes depending on the solvent used. Thus, FIG. 3 shows that samples of carbon black that were the same by standard morphology tests are shown to be different from each other when tested using different liquids. Therefore, these values can be used as a QC/QA method for the carbon black and would provide better product consistency than the typical morphological values alone. Additional use of any of the morphological values would provide for even better product consistency.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method of providing product consistency comprising the steps of:
a) obtaining at least two absorptometry curves, wherein at least one first absorptometry curve is obtained by combining a particulate material with a first liquid in an absorptometer and at least one second absorptometry curve is obtained by combining the particulate material with a second liquid in the absorptometer;
b) extracting at least one value from the first absorptometry curve and at least one value from the second absorptometry curve; and
c) maintaining the value from the first absorptometry curve within a first target range and maintaining the value from the second absorptometry curve within a second target range for the particulate material.

2. The method of claim 1, wherein the particulate material is carbonaceous.

3. The method of claim 1, wherein the particulate material is carbon black.

4. The method of claim 1, wherein the first liquid and the second liquid are selected from the group consisting of: dibutyl phthalate, paraffin oil, water, ethylene glycol, and mixtures thereof.

5. The method of claim 1, wherein the first absorptometry curve and the second absorptometry curve are obtained by measuring torque versus volume of the liquid added.

6. The method of claim 1, wherein the values extracted from the first absorptometry curve and the second absorptometry curve are selected from the group consisting of: the maximum torque, the volume of liquid at the maximum torque, the volume of liquid at a percentage of the maximum torque, the volume of liquid at which the absorptometry curve begins to rise, or combinations thereof.

7. The method of claim 1, further comprising the step of adjusting at least one process variable of a process for producing the particulate material, wherein the adjustment maintains the values within the target ranges.

8. The method of claim 7, wherein the process variable is selected from the group consisting of: combustion stoichiometry, reactor quench length, feedstock composition, primary fuel type, level of downstream additives, and post treatment conditions.

9. The method of claim 1, further comprising the step of maintaining at least one morphological value within a morphological target range.

10. The method of claim 1, further comprising the step of maintaining at least one chemical value within a chemical target range.

11. The method of claim 1, wherein the values are determined during the process for producing the particulate material.

12. The method of claim 1, wherein the values are determined prior to shipping the particulate material to a customer.

13. The method of claim 1, wherein the method is a quality control method.

14. The method of claim 1, wherein the values are extracted on a routine basis to insure quality control.

15. The method of claim 1, wherein the method is a quality assurance method.

16. The method of claim 1, wherein the values are extracted on a routine basis to insure quality assurance.

17. A method of providing product consistency comprising the steps of:
a) obtaining an absorptometry curve by combining a particulate material with a liquid in an absorptometer;
b) extracting at least two different values from the absorptometry curve; and
c) maintaining the values within target ranges for the particulate material.

18. The method of claim 17, wherein the particulate material is carbonaceous.

19. The method of claim 17, wherein the particulate material is carbon black.

20. The method of claim 17, wherein the liquid is selected from the group consisting of: dibutyl phthalate, paraffin oil, water, ethylene glycol, and mixtures thereof.

21. The method of claim 17, wherein the absorptometry curve is obtained by measuring torque versus volume of the liquid added.

22. The method of claim 17, wherein the values extracted from the absorptometry curve are selected from the group consisting of: the maximum torque, the volume of liquid at the maximum torque, the volume of liquid at a percentage of the maximum torque, the volume of liquid at which the absorptometry curve begins to rise, or combinations thereof.

23. The method of claim 17, further comprising the step of adjusting at least one process variable of a process for producing the particulate material, wherein the adjustment maintains the values within the target ranges.

24. The method of claim 23, wherein the process variable is selected from the group consisting of: combustion stoichiometry, reactor quench length, feedstock composition, primary fuel type, level of downstream additives, and post treatment conditions.

25. The method of claim 17, further comprising the step of maintaining at least one morphological value within a morphological target range.

26. The method of claim 17, further comprising the step of maintaining at least one chemical value within a chemical target range.

27. The method of claim 17, wherein the values are determined during the process for producing the particulate material.

28. The method of claim 17, wherein the values are determined prior to shipping the particulate material to a customer.

29. The method of claim 17, wherein the method is a quality control method.

30. The method of claim 17, wherein the values are extracted on a routine basis to insure quality control.

31. The method of claim 17, wherein the method is a quality assurance method.

32. The method of claim 17, wherein the values are extracted on a routine basis to insure quality assurance.

33. A method of providing product consistency comprising the steps of:
a) obtaining an absorptometry curve by combining a particulate material with a liquid in an absorptometer;
b) extracting at least one value from the absorptometry curve; and
c) maintaining the value within a target range for the particulate material, wherein the liquid is not dibutyl phthalate or a hydrocarbon.

34. The method of claim 33, wherein the particulate material is carbonaceous.

35. The method of claim 33, wherein the particulate material is carbon black.

36. The method of claim 33, wherein the liquid is selected from the group consisting of: water, ethylene glycol, and mixtures thereof.

37. The method of claim 33, wherein the absorptometry curve is obtained by measuring torque versus volume of the liquid added.

38. The method of claim 33, wherein the value extracted from the absorptometry curve is selected from the group consisting of: the maximum torque, the volume of liquid at the maximum torque, the volume of liquid at a percentage of the maximum torque, the volume of liquid at which the absorptometry curve begins to rise, or combinations thereof.

39. The method of claim 33, further comprising the step of adjusting at least one process variable of a process for producing the particulate material, wherein the adjustment maintains the value within the target range.

40. The method of claim 39, wherein the process variable is selected from the group consisting of: combustion stoichiometry, reactor quench length, feedstock composition, primary fuel type, level of downstream additives, and post treatment conditions.

41. The method of claim 33, further comprising the step of maintaining at least one morphological value within a morphological target range.

42. The method of claim 33, further comprising the step of maintaining at least one chemical value within a chemical target range.

43. The method of claim 33, wherein the value is determined during the process for producing the particulate material.

44. The method of claim 33, wherein the value is determined prior to shipping the particulate material to a customer.

45. The method of claim 33, wherein the method is a quality control method.

46. The method of claim 33, wherein the value is extracted on a routine basis to insure quality control.

47. The method of claim 33, wherein the method is a quality assurance method.

48. The method of claim 33, wherein the values are extracted on a routine basis to insure quality assurance.

49. A method of providing product consistency comprising the steps of:
a) obtaining an absorptometry curve by combining a particulate material with a liquid in an absorptometer;
b) extracting at least one value from the absorptometry curve; and
c) maintaining the value within a target range for the particulate material, wherein the value is not the characteristic volume.

50. The method of claim 49, wherein the particulate material is carbonaceous.

51. The method of claim 49, wherein the particulate material is carbon black.

52. The method of claim 49, wherein the liquid is selected from the group consisting of: dibutyl phthalate, paraffin oil, water, ethylene glycol, and mixtures thereof.

53. The method of claim 49, wherein the absorptometry curve is obtained by measuring torque versus volume of the liquid added.

54. The method of claim 49, wherein the value extracted from the absorptometry curve is selected from the group consisting of: the maximum torque, the volume of liquid at which the absorptometry curve begins to rise, or combinations thereof.

55. The method of claim 49, further comprising the step of adjusting at least one process variable of a process for producing the particulate material, wherein the adjustment maintains the value within the target range.

56. The method of claim 55, wherein the process variable is selected from the group consisting of: combustion stoichiometry, reactor quench length, feedstock composition, primary fuel type, level of downstream additives, and post treatment conditions.

57. The method of claim 49, further comprising the step of maintaining at least one morphological value within a morphological target range.

58. The method of claim 49, further comprising the step of maintaining at least one chemical value within a chemical target range.

60. The method of claim 49, wherein the value is determined during the process for producing the particulate material.

61. The method of claim 49, wherein the value is determined prior to shipping the particulate material to a customer.

62. The method of claim 49, wherein the method is a quality control method.

63. The method of claim 49, wherein the value is extracted on a routine basis to insure quality control.

64. The method of claim 49, wherein the method is a quality assurance method.

65. The method of claim 49, wherein the values are extracted on a routine basis to insure quality assurance.

66. A method of providing product consistency comprising the step of:
maintaining at least one value extracted from at least two absorptometry curves of a particulate material within target ranges, wherein at least one first absorptometry curve is obtained by combining the particulate material with a first liquid in an absorptometer; and wherein at least one second absorptometry curve is obtained by combining the particulate material with a second liquid in an absorptometer.

67. A method of providing product consistency comprising the step of:
maintaining at least two different values extracted from an absorptometry curve of a particulate material within target ranges, wherein the absorptometry curve is obtained by combining the particulate material with a liquid in an absorptometer.

68. A method of providing product consistency comprising the step of:
maintaining at least one value extracted from an absorptometry curve of a particulate material within a target range, wherein the absorptometry curve is obtained by combining the particulate material with a liquid in an absorptometer, and wherein the liquid is not dibutyl phthalate or a hydrocarbon.

69. A method of providing product consistency comprising the step of:
maintaining at least one value extracted from an absorptometry curve of a particulate material within a target range, wherein the absorptometry curve is obtained by combining the particulate material with a liquid in an absorptometer, and wherein the value is not the characteristic volume.
